(19) United States
(12) Patent Application Publication
(10) Pub. No.: US 2023/0410776 A1
(43) Pub. Date: Dec. 21, 2023

(54) SYSTEM AND METHOD FOR MASKING PERIODIC NOISE

(71) Applicants: Hyundai Motor Company, Seoul (KR); Kia Corporation, Seoul (KR)

(72) Inventor: Kyoung-Jin Chang, Suwon (KR)

(21) Appl. No.: 18/078,062

(22) Filed: Dec. 8, 2022

(30) Foreign Application Priority Data
Jun. 16, 2022 (KR) 10-2022-0073457

(51) Int. Cl. G10H 1/00

(52) U.S. Cl. CPC G10H 1/0025; G10H 2210/076; G10H 2210/375

(57) ABSTRACT

A system and method for masking periodic noise, which may be capable of efficiently masking periodic noise by outputting music made by synthesizing a song and a beat sound. The system may include at least one sensor configured to detect a periodic noise signal, at least one memory configured to store at least one song and at least one beat sound, a speaker, and at least one processor configured to select a first song and a first beat sound from the at least one song and the at least one beat sound, adjust a tempo of the first song, determine a playing period of the first beat sound, and/or control the speaker to output music made by synthesizing the first song with the adjusted tempo and the first beat sound that may be repeated in accordance with the determined playing period.

### CROSS-REFERENCE TO RELATED APPLICATION(S)

This application claims under 35 U.S.C. § 119(a) the benefit of priority to Korean Patent Application No. 10-2022-0073457, filed on Jun. 16, 2022, in the Korean Intellectual Property Office, the disclosure of which is incorporated herein by reference.

### TECHNICAL FIELD

The present disclosure relates to a system and method for masking periodic noise, and more particularly, to a system and method for masking periodic noise, which may be capable of masking periodic noise by using a signal made by synthesizing a song and a beat sound.

### BACKGROUND

As a method for reducing household noise, there have been used a method of reducing noise by installing a sound absorber, a sound insulator, and the like for blocking a transmission route of a noise source, and a method of masking noise by using sound having an opposite phase and generated from a speaker by applying an active noise control (ANC) logic.

In case that the above-mentioned technology may be applied to a vehicle, there may be problems in that weight and material costs may be increased, an expensive controller may be required, and an effect of reducing periodic noise may not be high.

Meanwhile, there may be a method of outputting another sound (e.g., music) through a speaker to reduce noise. However, it may be necessary to increase a magnitude of negative pressure of the sound to efficiently block the periodic noise.

### SUMMARY

An embodiment of the disclosure may be to provide a system and method for masking periodic noise, which may be capable of efficiently masking periodic noise by outputting music made by synthesizing a song and a beat sound.

In accordance with an embodiment of the disclosure, a system for masking periodic noise includes: at least one sensor configured to detect a periodic noise signal; at least one memory configured to store and having stored at least one song and at least one beat sound; a speaker; and at least one processor configured to: select a first song and a first beat sound from the at least one song and the at least one beat sound based on at least one of a period of the periodic noise signal or an amplitude of the periodic noise signal; adjust a tempo of the first song based on the period of the periodic noise signal; determine a playing period of the first beat sound based on the period of the periodic noise signal; control the speaker to output music made by synthesizing the first song with the adjusted tempo and the first beat sound that may be repeated in accordance with the determined playing period; or any combination thereof.

In addition, the at least one processor may adjust the tempo of the first song so that a beat period of the first song may be N or 1/N (where N may be a natural number) times the period of the periodic noise signal.

In addition, the at least one processor may be configured to determine the playing period of the first beat sound so that the playing period of the first beat sound may be N or 1/N (where N may be a natural number) times the period of the periodic noise signal.

In addition, the at least one processor may adjust a playing point in time of the music so that a beat of the periodic noise signal may be coincident with a beat of the music.

In addition, the at least one processor may predict a generation point in time of the periodic noise signal based on the period of the periodic noise signal and control the speaker to play the music at the predicted generation point in time.

In addition, based on the period of the periodic noise signal being changed by a preset ratio or more, the at least one processor may readjust the tempo of the first song, redetermine the playing period of the first beat sound, produce resynthesized music made by synthesizing the first song with the readjusted tempo and the first beat sound repeated in accordance with the redetermined playing period, stop an output of the music, and control the speaker to output the resynthesized music.

In addition, based on the period of the periodic noise signal being changed by a preset ratio or more, the at least one processor may be configured to select a second song different from the first song from the at least one song having at least two songs, adjust a tempo of the second song based on the period of the periodic noise signal, redetermine the playing period of the first beat sound based on the period of the periodic noise signal, and control the speaker to output resynthesized music made by synthesizing the second song with the adjusted tempo and the first beat sound that may be repeated in accordance with the redetermined playing period.

In addition, based on the amplitude of the periodic noise signal being changed by a preset ratio or more, the at least one processor may be configured to select a second beat sound different from the first beat sound from the at least one beat sound having at least two beat sounds and control the speaker to output resynthesized music made by synthesizing the first song with the adjusted tempo and the second beat sound that may be repeated in accordance with the determined playing period.

In addition, based on the period of the periodic noise signal being changed by a first preset ratio or more, the at least one processor may be configured to select a second song different from the first song from the at least one song having at least two songs, select a second beat sound different from the first beat sound from the at least one beat sound having at least two beat sounds based on the amplitude of the periodic noise signal being changed by a second preset ratio or more, adjust a tempo of the second song based on the period of the periodic noise signal, determine a playing period of the second beat sound based on the period of the periodic noise signal, and control the speaker to output resynthesized music made by synthesizing the second song with the adjusted tempo and the second beat sound that may be repeated in accordance with the determined playing period.

The at least one processor may control the speaker to play the resynthesized music having passed through a fade-in filter.

In accordance with another embodiment of the disclosure, a method of masking periodic noise includes: detecting a periodic noise signal; selecting a first song and a first beat sound from pre-stored at least one song and pre-stored at least one beat sound based on at least one of a period and amplitude of the periodic noise signal; adjusting a tempo of the first song based on the period of the periodic noise signal; determining a playing period of the first beat sound based on the period of the periodic noise signal; and playing music made by synthesizing the first song with the adjusted tempo and the first beat sound that may be repeated in accordance with the determined playing period.

In addition, the adjusting of the tempo of the first song may include adjusting the tempo of the first song so that a beat period of the first song may be N or 1/N (where N may be a natural number) times the period of the periodic noise signal.

In addition, the determining of the playing period of the first beat sound may include determining the playing period of the first beat sound so that the playing period of the first beat sound may be N or 1/N (where N may be a natural number) times the period of the periodic noise signal.

In addition, the playing of the music may include adjusting a playing point in time of the music so that a beat of the periodic noise signal may be coincident with a beat of the music.

In addition, the adjusting of the playing point in time of the music may include: predicting a generation point in time of the periodic noise signal based on the period of the periodic noise signal; and playing the music at the predicted generation point in time.

The method of masking periodic noise according to the embodiment may further include: readjusting the tempo of the first song and redetermining the playing period of the first beat sound based on the period of the periodic noise signal being changed by a preset ratio or more; producing resynthesized music made by synthesizing the first song with the readjusted tempo and the first beat sound repeated in accordance with the redetermined playing period; and stopping the playing of the music and playing the resynthesized music.

The method of masking periodic noise according to the embodiment may further include: selecting a second song different from the first song from the at least one song having at least two songs based on the period of the periodic noise signal being change by a preset ratio or more; adjusting a second tempo of the second song based on the period of the periodic noise signal; redetermining the playing period of the first beat sound based on the period of the periodic noise signal; and playing resynthesized music made by synthesizing the second song with the adjusted tempo and the first beat sound that may be repeated in accordance with the redetermined playing period.

The method of masking periodic noise according to the embodiment may further include: selecting a second beat sound different from the first beat sound from the at least one beat sound having at least two beat sounds based on the amplitude of the periodic noise signal being changed by a preset ratio or more; and playing resynthesized music made by synthesizing the first song with the adjusted tempo and the second beat sound that may be repeated in accordance with the determined playing period.

The method of masking periodic noise according to the embodiment may further include: selecting a second song different from the first song from the at least one song having at least two songs based on the period of the periodic noise signal being changed by a first preset ratio or more; selecting a second beat sound different from the first beat sound from the at least one beat sound having at least two beat sounds based on the amplitude of the periodic noise signal being changed by a second preset ratio or more; adjusting a tempo of the second song based on the period of the periodic noise signal; determining a playing period of the second beat sound based on the period of the periodic noise signal; and playing resynthesized music made by synthesizing the second song with the adjusted tempo and the second beat sound that may be repeated in accordance with the determined playing period.

In addition, the playing of the resynthesized music may include playing the resynthesized music having passed through a fade-in filter.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 is a view schematically illustrating a configuration of a system for masking periodic noise according to an embodiment;

FIG. 2 is a view illustrating a functional configuration of a controller according to the embodiment;

FIG. 3 is a view illustrating a functional configuration of a signal analyzer according to the embodiment;

FIG. 4 is a view illustrating a functional configuration of a modulator according to the embodiment;

FIG. 5 is a view illustrating a functional configuration of a synchronizer according to the embodiment;

FIGS. 6 and 7 are flowcharts illustrating a method of masking periodic noise according to the embodiment;

FIG. 8 is a view illustrating examples of information on songs stored in a memory according to the embodiment;

FIG. 9 is a view illustrating examples of elements that constitute music produced based on a period of a periodic noise signal; and

FIG. 10 is a view illustrating an example in which tempos of songs and playing periods of beat sounds are adjusted in case that the period of the periodic noise signal changes.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

The present specification does not explain all the elements in the embodiments, and the general contents in the technical field to which the present disclosure pertains or the contents repeatedly described in the embodiments will be omitted.

Throughout the present specification, when one constituent element may be referred to as being “connected to” another constituent element, one constituent element may be “directly connected to” the other constituent element, and one constituent element may also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Singular expressions include plural expressions unless there may be an exception in the context.

In addition, the term “part,” “device,” “block,” “member,” “module,” or the like may mean a unit that processes one or more functions or operations. For example, the term may mean at least one process processed by at least one hardware stored in a field-programmable gate array (FPGA), an application specific integrated circuit (ASIC), or the like, or at least one software or processor stored in a memory.

The reference numeral assigned to each step may be used to identify each step, and the reference numeral does not represent the order between the steps. Each step may be performed regardless of the specified order unless the specified order may be clearly described in the context.

Hereinafter, embodiments of a system and method of masking periodic noise according to one embodiment will be described in detail with reference to the accompanying drawings.

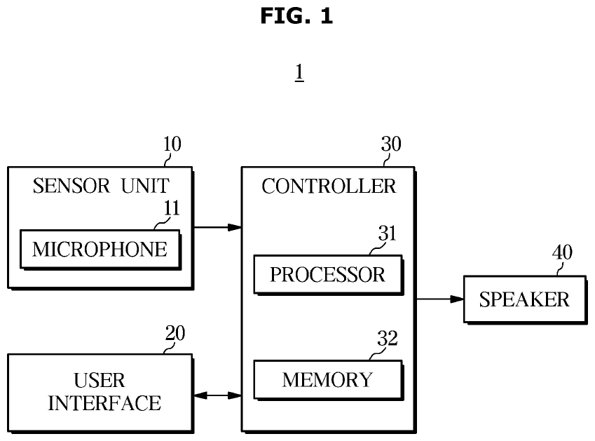

FIG. 1 is a view schematically illustrating a configuration of a system for masking periodic noise according to an embodiment.

Referring to FIG. 1, to mask periodic noise, a system 1 for masking periodic noise according to an embodiment may include a sensor unit 10, a user interface unit 20, a controller 30, and/or a speaker 40.

A periodic noise signal means periodically generated noise. Exemplary period noise may include any combination of an impactive mechanical sound, high-frequency sound of a vehicle generated at predetermined intervals, footstep sound, and/or nailing sound. Although these described sounds are provided as examples, the disclosure is not limited. Instead a period noise signal may be any repeating sound that may be received or heard. As used herein, the noise is shown and described as periodically occurring. The period of the noise need not be constant or exactly repeating. Instead, the period may be some multiple of a period that is approximately equal. The approximation would be understood by a person of skill in the art considering the accuracy of the components used to measure and calculate the period and/or in the systems and methods used to mask the periodic noise including, for example, the sound of the beat and/or song selected or adjusted to mask the period sound. The approximation of the period, amplitude, or other sound characteristic may also or alternatively be related to the rations or change threshold used to determine whether another song or beat should be selected. The system therefore is design to permit variation in the periodically generated noise that would be understood by a person of skill in the art.

Therefore, the system 1 for masking periodic noise may be installed at various positions at which the periodic noise may be generated.

For example, the system 1 for masking periodic noise may be installed in a house to mask floor noise or lateral noise.

As another example, the system 1 for masking periodic noise may be installed in a vehicle to mask various types of noise generated in the vehicle.

The periodic noise signal may have different periods or frequencies and amplitude characteristics depending on the types of noise.

The sensor unit 10 may include at least one sensor configured to detect the periodic noise signal.

For example, the sensor unit 10 may include at least one microphone 11 configured to detecting the periodic noise signal.

The at least one microphone 11 may receive periodic noise and output the periodic noise as an electrical signal (periodic noise signal).

As another example, in case the system 1 for masking periodic noise may be provided in the vehicle, the sensor unit 10 may include a vibration sensor capable of detecting vibration of an engine of the vehicle, and/or an engine revolutions per minute (RPM) sensor configured to detect an operating state of the engine.

The vibration sensor may be provided not only on a suspension or a sub-frame of the vehicle but also or alternatively at various positions at which the vibration sensor may detect vibration transmitted to the vehicle.

The vibration sensor(s) may include an acceleration sensor configured to measure three-axis (X-axis, Y-axis, and Z-axis) acceleration. For example, the vibration sensor may be configured as a piezoelectric-type vibration sensor, a strain gauge-type vibration sensor, a piezoresistive-type vibration sensor, a capacitive-type vibration sensor, a servo-type vibration sensor, or an optical-type acceleration sensor. In addition, the vibration sensor may be configured as various sensors (e.g., a gyroscope) capable of measuring vibration transmitted to the system 1 for masking periodic noise.

The sensor unit 10 may be configured to transmit the periodic noise signal to the controller and the controller 30 may be configured to process the periodic noise signal.

For example, in case the periodic noise signal corresponds to analog data, the controller may be configured to convert the analog data into digital data using an analog to digital converter (ADC) filter and then process the digital data.

The user interface unit 20 may include a display configured to display various types of information in respect to a periodic noise masking function, and an input device configured to receive various types of user inputs in respect to the periodic noise masking function.

The display may be a light-emitting diode (LED) panel, an organic light-emitting diode (OLED) panel, a liquid crystal display panel, and/or an indicator. In addition, the display may include a touch screen.

In case that the system 1 for masking periodic noise may be installed in the vehicle, the display may include a navigation device, a head-up display, and/or a cluster.

The display may provide various types of user interfaces that may allow the user to set up the periodic noise masking function.

The input device may include a button, a dial, and/or a touch pad. For example, the input device may include a push button, a touch button, a touch pad, a touch screen, a dial, a stick-type operating device, and/or a track ball. In case that the input device may be implemented as a touch screen, the input device may be integrated with the display.

In the embodiment, the user interface unit 20 may be configured to provide a user interface for activating and deactivating the system 1 for masking periodic noise. The user may activate and deactivate the system 1 for masking periodic noise using the user interface unit 20.

In addition, the user interface unit 20 may be configured to provide the user interface for setting up the function of the system 1 for masking periodic noise. For example, the user interface unit 20 may be configured to provide an interface that allows the user to select a song that the user wants to hear, and/or an interface that allows the user to select a beat sound that the user wants to add to the song.

The user may use the user interface unit 20 and select at least one song that the user wants to hear among the songs stored in a memory 32 or select at least one beat sound that the user wants to use among the beat sounds stored in the memory 32.

The songs may include all types of musical works. For example, the songs may include not only musical works, such as melodies or pop songs with lyrics but also musical works as orchestra and instrumental songs without lyrics.

The beat sound may mean sound for beating time or representing a tempo. The beat sound may include various types of sounds corresponding to one beat.

For example, the beat sound may include not only an instrumental sound corresponding to one beat but also various sounds such as a tapping sound, a horn sound, or the like corresponding to one beat.

The controller 30 may include the at least one memory 32 configured to store a program and/or information that performs the above-mentioned operations and the following operations, and at least one processor 31 configured to execute the stored program. In case the controller 30 includes a plurality of memories 32 and a plurality of processors 31, the plurality of memories 32 and the plurality of processor 31 may be integrated on a single chip or physically separated.

In case the system 1 for masking periodic noise may be provided in the vehicle, the controller 30 may include at least one processor 31 mounted on a head, an AVNT (audio, video, navigation, and telematics) terminal, or the like of the vehicle. However, the present disclosure may not be limited thereto. The controller 30 may include a separate processor 31 provided in the vehicle.

The controller 30 may be configured to modulate the song stored in the memory 32 based on a result of processing the periodic noise signal detected by the sensor unit 10 and produce music by synthesizing the modulated song and the beat sound.

The controller 30 may be configured to control the speaker 40 to output the music produced based on the result of processing the periodic noise signal.

The speaker 40 may output the music based on an electrical signal corresponding to the music transmitted from the controller 30.

Because the speaker 40 outputs the music produced based on the periodic noise signal, the user may listen to the music without recognizing the periodic noise.

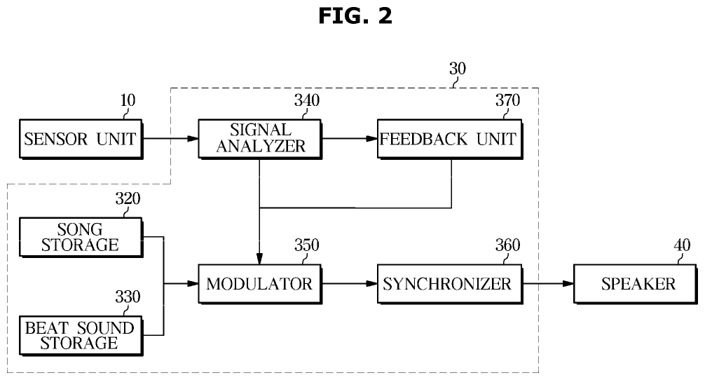

FIG. 2 is a view illustrating a functional configuration of the controller according to the embodiment.

Referring to FIG. 2, the controller 30 may include a song storage 320, a beat sound storage 330, a signal analyzer 340, a modulator 350, a synchronizer 360, a feedback unit.

The song storage 320 may be implemented as at least one memory 32 and store at least one song or at least two songs. For example, the song storage 320 may store a plurality of songs (e.g., dance songs, pop songs, instrumental songs, and the like) having different musical characteristics (e.g., beats per minute (BPM)).

According to various embodiments, the plurality of songs may include different numbers of beats per minute of about 60 BPM to 150 BPM. The BPM may be an abbreviation of beat per minute and means the number of beats per minute.

The song storage 320 may also store data musical characteristics (e.g., BPM) of the plurality of songs.

The beat sound storage 330 may be implemented as at least one memory 32 and store at least one beat sound or at least two beat sounds. For example, the beat sound storage 330 may store a plurality of beat sounds (e.g., snare drum sound, bass drum sound, Hi-Hat sound, Tom Tom sound, crash cymbal sound, ride cymbal sound, bass guitar sound, timpani sound, and the like) having different musical characteristics (e.g., amplitude characteristics and frequency characteristics).

The plurality of beat sounds may be stored in the form of a synthesizer sound source to adjust the number of beats and sound volume.

The beat sound storage 330 may also store data in respect to main frequency components and magnitudes of the plurality of beat sounds.

The plurality of songs and/or the plurality of beat sounds may be stored in the at least one memory 32 through a communication interface (not illustrated) of the system 1 for masking periodic noise.

For example, the communication interface may include a port electrically connected to an external storage device, and/or a wireless communication module configured to perform wireless communication (e.g., Bluetooth communication, Wi-Fi communication, and data communication) with the external storage device.

The user may store the user's favorite song and beat sound in the memory 32 through the communication interface.

The signal analyzer 340 may process the periodic noise signal detected by the sensor unit 10. To this end, the signal analyzer 340 may include an ADC filter configured to convert the periodic noise signal, which may be an analog data, into digital data, and a digital signal processor configured to process the digital signal.

The signal analyzer 340 may be configured to analyze the characteristics of the periodic noise signal based on the result of processing the periodic noise signal. More specifically, when the periodic noise signal may be inputted, the signal analyzer 340 may extract a main frequency, a generation period, an amplitude, and the like by analyzing the periodic noise signal.

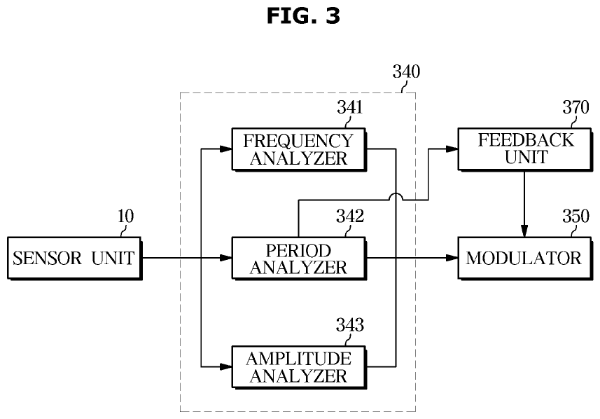

FIG. 3 is a view illustrating a functional configuration of the signal analyzer according to the embodiment.

Referring to FIG. 3, the signal analyzer 340 may include a frequency analyzer 341 configured to extract frequency characteristics of the periodic noise signal, a period analyzer 342 configured to extract period characteristics of the periodic noise signal, and an amplitude analyzer 343 configured to extract amplitude characteristics of the periodic noise signal.

The frequency analyzer 341 may analyze the frequency characteristics of the periodic noise signal inputted in real time by using frequency analysis techniques such as fast Fourier transform (FFT) or short time Fourier transform (STFT).

The period analyzer 342 may determine the period of the periodic noise signal based on a result of processing the periodic noise signal in a time domain.

The amplitude analyzer 343 may determine a maximum amplitude of the periodic noise signal based on a result of processing the periodic noise signal in the time domain. In addition, the amplitude analyzer 343 may calculate an RMS level in a frequency spectrum based on a result of processing the periodic noise signal in a frequency domain.

The data related to the frequency characteristics, periods, and amplitude characteristics of the periodic noise signal may be transmitted to the modulator 350.

According to various embodiments, the data related to the period of the periodic noise signal may be transmitted to the feedback unit 370.

The feedback unit 370 may be configured to monitor in real time the period of the periodic noise signal. When the period of the periodic noise signal changes by a preset ratio (e.g., 10% to 20%) or more, the feedback unit 370 may request the modulator 350 to reselect and/or remodulate the song or request the modulator 350 to reselect the beat sound and/or redetermine a playing period of the beat sound.

The data related to the preset ratio may be stored in the memory 32 and set to be about 10% to 20% or less so that the music outputted from the speaker 40 does not change too often.

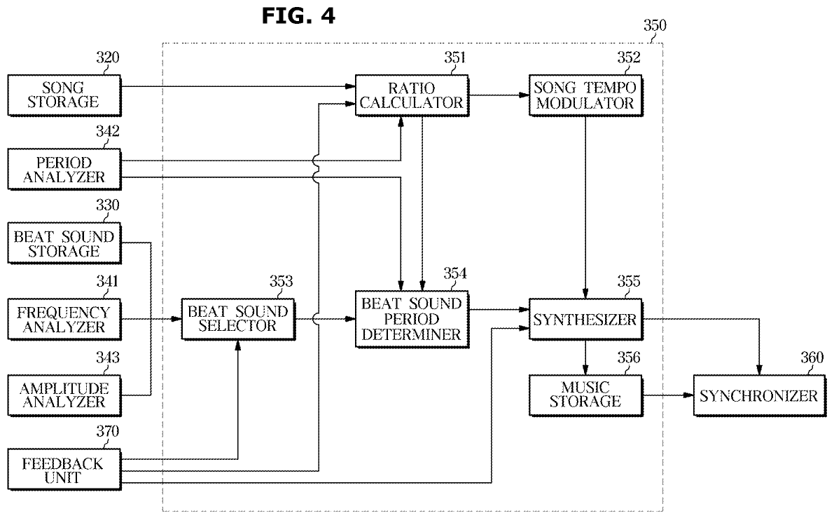

FIG. 4 is a view illustrating a functional configuration of the modulator according to the embodiment.

Referring to FIG. 4, the modulator 350 may be configured to produce the music based on the frequency characteristics, periods, and amplitude characteristics of the periodic noise signal and transmit the produced music to the synchronizer 360.

Specifically, the modulator 350 serves to modulate the BPM of the song so that the BPM of the song, which may be selected from the plurality of songs stored in the song storage 320, corresponds to the period of the periodic noise signal. The modulator 350 serves to determine the playing period of the beat sound so that the playing period of the beat sound, which may be selected from the plurality of beat sounds stored in the beat sound storage 330, corresponds to the period of the periodic noise signal. The modulator 350 serves to determine a magnitude of the beat sound so that a magnitude of the periodic noise signal corresponds to a magnitude of the beat sound. The modulator 350 serves to synthesize the beat sound and the song with the modulated BPM.

To this end, the modulator 350 may include a ratio calculator 351, a song tempo modulator 352, a beat sound selector 353, a beat sound tempo modulator 350, a beat sound period determiner 354, a synthesizer 355, and a music storage 356.

The ratio calculator 351 selects any one song (hereinafter, referred to as a ‘first song’) among the plurality of songs stored in the song storage 320 and adjusts a tempo of the first song based on the period of the periodic noise signal. The adjustment of the tempo of the first song may mean the modulation of the BPM of the first song.

According to various embodiments, the ratio calculator 351 may select the first song, which corresponds to a current playing order among the plurality of songs stored in the song storage 320, based on the playing order.

In addition, the ratio calculator 351 may select the first song, which may be most similar in beat period to the period of the periodic noise signal among the plurality of songs stored in the song storage 320, based on the period of the periodic noise signal.

As another example, the ratio calculator 351 may select the first song similar in N (where N may be a natural number) times the beat period or 1/N times the beat period to the period of the periodic noise signal among the plurality of songs stored in the song storage 320. Particularly, N may be 3 or less. The similarity for the comparison may be close to the approximation as described herein. The similarity would be understood by a person of skill in the art to achieve the functions described herein including the masking of the periodic noise. The similarity may also or alternatively be based on a possible range of BPM range adjustments in which the song may sound appropriate to a user once modified as described herein.

The ratio calculator 351 may calculate a BPM change ratio of the first song to adjust the tempo of the first song so that the beat period of the first song corresponds to the period of the periodic noise signal.

The feedback unit 370 may be configured to store data related to the period of the periodic noise signal (hereinafter, referred to as a ‘usage period’) that may be used by the ratio calculator 351 to calculate the BPM change ratio of the first song.

Therefore, the feedback unit 370 may be configured to determine whether the period of the periodic noise signal, which may be monitored in real time, may be changed by 10% to 20% or more from the usage period.

In case that the period of the periodic noise signal changes by a preset ratio or more as described below, the ratio calculator 351 may select a second song different from the first song at the request of the feedback unit 370 and calculate a BPM change ratio of the second song to adjust a tempo of the second song so that a beat period of the second song corresponds to the period of the periodic noise signal.

The song tempo modulator 352 may modulate the tempo of the first song based on the BPM change ratio calculated by the ratio calculator 351. Therefore, the beat period of the first song with the adjusted tempo may correspond to the period of the periodic noise signal.

The configuration in which the beat period of the first song corresponds to the period of the periodic noise signal may mean that the beat period of the first song may be N or 1/N (where N may be a natural number) times the period of the periodic noise signal.

That is, the song tempo modulator 352 may adjust the tempo of the first song so that the beat period of the first song may be N or 1/N (N may be a natural number) times the period of the periodic noise signal.

The beat sound selector 353 may select a first beat sound from the plurality of beat sounds.

According to various embodiments, the beat sound selector 353 may be configured to select the first beat sound having amplitude characteristics most similar to amplitude characteristics of the periodic noise signal among the plurality of beat sounds. More specifically, the beat sound selector 353 may be configured to select the first beat sound having a maximum amplitude level sufficiently similar to a maximum amplitude level of the periodic noise signal among the plurality of beat sounds. The similarity of beat sounds may be understood by a person of skill in the art to permit a range for one or more selection criteria, such as amplitude and/or frequency, so that the periodic noise may be at least partially masked by the selected beat sound when synthesized with the song according to embodiments described herein. The comparison may also be across all of the beat sounds so that the beat sound selected is most appropriate for masking the periodic noise. As with the song selection, the similarity of the beat sound may also be based on the permutable variation of the period noise before another beat sound is selected.

In addition, the beat sound selector 353 may be configured to select the first beat sound having an root mean square (RMS) level most similar to an RMS level of the periodic noise signal in the frequency domain among the plurality of beat sounds.

As another example, the beat sound selector 353 may be configured to select the first beat sound having frequency characteristics most similar to or sufficiently similar to frequency characteristics of the periodic noise signal among the plurality of beat sounds.

For example, the beat sound selector 353 may be configured to select the first beat sound having a frequency range and/or main frequency most similar to or sufficiently similar to a frequency range and/or main frequency of the periodic noise signal among the plurality of beat sounds.

That is, the beat sound selector 353 may select the first beat sound based on the frequency characteristics and/or amplitude characteristics of the periodic noise signal.

In case that the frequency characteristics and/or amplitude characteristics of the periodic noise signal may be changed by a preset ratio or more as described below, the beat sound selector 353 may reselect a second beat sound different from the first beat sound.

The beat sound period determiner 354 may be configured to determine a playing period of the first beat sound selected by the beat sound selector 353 based on the period of the periodic noise signal.

For example, the beat sound period determiner 354 may be configured to determine the playing period of the first beat sound so that the playing period of the first beat sound may be N or 1/N (N may be a natural number) times the period of the periodic noise signal.

According to various embodiments, the beat sound period determiner 354 may modulate the amplitude characteristics of the first beat sound so that the amplitude characteristics of the first beat sound may be similar to the amplitude characteristics of the periodic noise signal.

The synthesizer 355 may superimpose and synthesize the first song, which has the tempo that has been adjusted by the song tempo modulator 352, and the first beat sound that has the playing period that has been determined by the beat sound period determiner 354.

Specifically, the synthesizer 355 may produce music (hereinafter, referred to as a ‘first music’) made by synthesizing the first song, which has the tempo that has been adjusted by the song tempo modulator 352, and the first beat sound that may be repeated in accordance with the playing period that has been determined by the beat sound period determiner 354.

A sound source of the first beat sound, which may be repeated in accordance with the playing period that has been determined by the beat sound period determiner 354, may be produced by the beat sound tempo modulator 350 or produced by the synthesizer 355.

The music storage 356 may store the music produced by the synthesizer 355. More specifically, the music storage 356 may store first music.

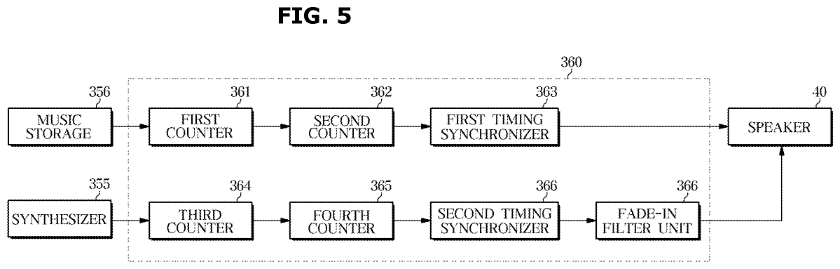

FIG. 5 is a view illustrating a functional configuration of the synchronizer according to the embodiment.

Referring to FIG. 5, the synchronizer 360 may be configured to adjust a playing point in time of the first music so that a beat of the periodic noise signal and a beat of the first music may be coincident with each other based on the received sound source of the first music.

The synchronizer 360 may predict a generation point in time of the periodic noise signal based on the period of the periodic noise signal and determine a playing point in time of the first music based on the predicted generation point in time.

To this end, the synchronizer 360 may include a first counter 361, a second counter 362, a timing synchronizer, a third counter 364, a fourth counter 365, and a fade-in filter unit 367.

Hereinafter, for the convenience of description, the assumption may be made that the synchronizer 360 receives the sound source of the first music.

The first counter 361 may be configured to determine the playing point in time of the first beat sound, which constitutes the first music, based on the received sound source of the first music. The playing point in time of the first beat sound may be determined based on the playing period determined by the beat sound period determiner 354. Therefore, the first counter 361 may determine which playing point in time may be the earliest playing point in time among the playing points in time of the first beat sound.

The second counter 362 may be configured to predict a generation point in time of the periodic noise signal based on the period of the periodic noise signal. That is, the second counter 362 may determine which predicted generation point in time may be the earliest predicted generation point in time among the predicted generation points in time of the periodic noise signal.

The first timing synchronizer 363 or 360 may be configured to determine the playing point in time of the first music based on the earliest playing point in time among the playing points in time of the first beat sound and the earliest predicted generation point in time among the predicted generation points in time of the periodic noise signal.

Specifically, the first timing synchronizer 363 or 360 may be configured to adjust the playing point in time of the first music so that the playing point in time of the first beat sound, which constitutes the first music, may be coincident with the predicted generation point in time of the periodic noise signal.

The first timing synchronizer 363 or 360 may be configured to predict the generation point in time of the periodic noise signal based on the period of the periodic noise signal and control the speaker 40 to play the first music at the predicted generation point in time.

Meanwhile, in case that the period of the periodic noise signal changes by 10% to 20% or more based on the usage period during a process of playing the first music, the synthesizer 355 may produce second music different in musical characteristics from the first music.

For example, based on the configuration in which the period of the periodic noise signal changes by a preset ratio or more, the synthesizer 355 may be configured to readjust the tempo of the first song, redetermine the playing period of the first beat sound, and produce resynthesized music (second music) made by synthesizing the first song with the readjusted tempo and the first beat sound that may be repeated in accordance with the redetermined playing period.

As another example, based on the configuration in which the period of the periodic noise signal changes by a preset ratio or more, the synthesizer 355 may be configured to select the second song different from the first song among at least one song having at least two songs, adjust the tempo of the second song based on the period of the periodic noise signal, redetermine the playing period of the first beat sound based on the period of the periodic noise signal, and produce the resynthesized music (second music) made by synthesizing the second song with the adjusted tempo and the first beat sound that may be repeated in accordance with the redetermined playing period.

As another example, based on the configuration in which the amplitude of the periodic noise signal changes by a preset ratio (e.g., about 10%) or more, the synthesizer 355 may select the second beat sound different from the first beat sound among at least one beat sound having at least two beat sounds and produce the resynthesized music (second music) made by synthesizing the first song with the adjusted tempo and the second beat sound that may be repeated in accordance with the determined playing period.

As another example, the synthesizer 355 may be configured to select the second song different from the first song among at least one song having at least two songs based on the configuration in which the period of the periodic noise signal changes by a first preset ratio or more. Further, the synthesizer 355 may be configured to select the second beat sound different from the first beat sound among at least one beat sound having at least two beat sounds based on the configuration in which the amplitude of the periodic noise signal changes by a second preset ratio or more. Further, the synthesizer 355 may adjust the tempo of the second song based on the period of the periodic noise signal, determine a playing period of the second beat sound based on the period of the periodic noise signal, and produce resynthesized music (second music) made by synthesizing the second song with the adjusted tempo and the second beat sound that may be repeated in accordance with the determined playing period.

As described above, the second music may mean the sound source different in musical characteristics from the first music.

The third counter 364 may determine a playing point in time of the beat sound (e.g., the first beat sound or the second beat sound), which constitutes the second music, based on the configuration in which the period of the periodic noise signal changes by a preset ratio or more and then the sound source of the second music may be received. The playing point in time of the beat sound, which constitutes the second music, may be determined based on the playing period determined by the beat sound period determiner 354. Therefore, the third counter 364 may determine which playing point in time may be the earliest playing point in time among the playing points in time of the beat sound that constitutes the second music.

The fourth counter 365 may predict the generation point in time of the periodic noise signal after the period of the periodic noise signal changes by a preset ratio or more based on the period of the periodic noise signal. That is, the fourth counter 365 may determine which predicted generation point in time may be the earliest predicted generation point in time among the predicted generation points in time of the periodic noise signal after the period of the periodic noise signal changes by a preset ratio or more.

The second timing synchronizer 366 or 360 may be configured to determine the playing point in time of the second music based on the earliest playing point in time among the playing points in time of the beat sound, which constitutes the second music, and the earliest predicted generation point in time among the predicted generation points in time of the periodic noise signal after the period of the periodic noise signal changes by a preset ratio or more.

Specifically, the second timing synchronizer 366 or 360 may be configured to adjust the playing point in time of the second music so that the playing point in time of the beat sound (e.g., the first beat sound or the second beat sound), which constitutes the second music, may be coincident with the predicted generation point in time of the periodic noise signal.

The fade-in filter unit 367 may be a component for minimizing heterogeneous feeling caused by the superimposition of the first music being played previously and the second music to be played later.

The fade-in filter unit 367 may include a filter capable of providing a fade-in effect to the second music. For example, the fade-in filter unit 367 may include a filter configured to gradually increase the sound volume of the second music. The fade-in filter unit 367 may be implemented as hardware such as a circuit component or implemented as software.

The second timing synchronizer 366 or 360 may be configured to predict the generation point in time of the periodic noise signal based on the period of the periodic noise signal and control the speaker 40 to play the second music at the predicted generation point in time.

According to various embodiments, the second timing synchronizer 366 or 360 may be configured to control the speaker 40 to play the second music having passed through a fade-in filter roll.

Meanwhile, the first timing synchronizer may control the speaker 40 to stop an output of the first music immediately or stop an output of the first music after a preset time based on the configuration in which the second music may be played.

While the functional configurations of the controller 30 have been described above with reference to FIGS. 2 to 5, the configurations may be implemented as at least one processor 31 and/or at least one memory 32.

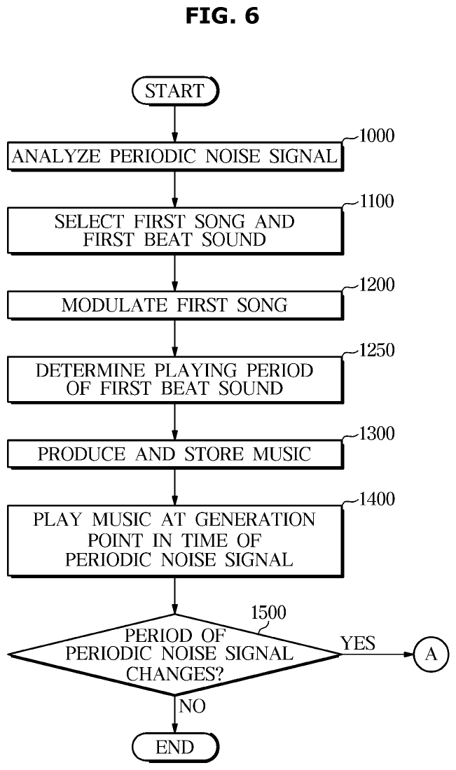

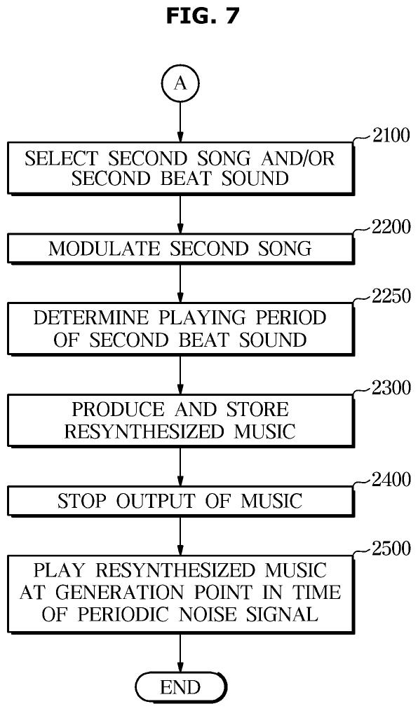

FIGS. 6 and 7 are flowcharts of a method of masking periodic noise according to the embodiment.

Referring to FIG. 6, the controller 30 may analyze the periodic noise signal detected by the sensor unit 10 (1000).

More specifically, when the periodic noise signal is inputted, the controller 30 may extract a main frequency, a generation period, an amplitude, and the like by analyzing the periodic noise signal.

The controller 30 may be configured to select the first song and the first beat sound from at least one song and at least one beat sound stored in the memory 32 based on at least one of the period and amplitude of the periodic noise signal (1100).

More specifically, the controller 30 may be configured to select the first song most similar in beat period to the period of the periodic noise signal among the plurality of songs stored in the memory 32 based on the period of the periodic noise signal. The controller 30 may select the first beat sound having the amplitude characteristics most similar to the amplitude characteristics of the periodic noise signal among the plurality of beat sounds stored in the memory 32 based on the amplitude of the periodic noise signal.

The controller 30 may be configured to modulate the first song based on the period of the periodic noise signal (1200).

More specifically, the controller 30 may adjust the tempo of the first song so that the beat period of the first song is N or 1/N (N is a natural number) times the period of the periodic noise signal.

In addition, the controller 30 may be configured to determine the playing period of the first beat sound so that the playing period of the first beat sound is N or 1/N (N is a natural number) times the period of the periodic noise signal (1250).

Thereafter, the controller 30 may be configured to produce the music made by synthesizing the first song with the adjusted tempo and the first beat sound that is repeated in accordance with the previously determined playing period, and the controller 30 may store the produced music (hereinafter, referred to as the ‘first music’) (1300).

The controller 30 may be configured to adjust the playing point in time of the first music so that the beat of the periodic noise signal is coincident with the beat of the first music, and the controller 30 may play the first music at the generation point in time of the periodic noise signal (1400).

For example, the controller 30 may be configured to predict the generation point in time of the periodic noise signal based on the period of the periodic noise signal and control the speaker 40 to play the first music at the predicted generation point in time.

The configuration in which the beat of the periodic noise signal is coincident with the beat of the first music may mean that the generation point in time of the periodic noise signal is coincident with the playing point in time of the first beat sound that constitutes the first music.

Thereafter, the controller 30 may be configured to monitor in real time the characteristics of the periodic noise signal detected by the sensor unit 10 and determine whether the period of the periodic noise signal changes by a preset ratio or more (1500).

In this case, the configuration in which the period of the periodic noise signal changes by the preset ratio or more means that the period of the periodic noise signal changes by the preset ratio or more based on the period of the periodic noise signal value, which has been used to adjust the tempo of the first song, or the period of the periodic noise signal value that has been used to determine the playing period of the first beat sound.

The controller 30 may be configured to end one control cycle when the period of the periodic noise signal does not change by the preset ratio or more (NO in 1500) during the process of playing the first music.

Meanwhile, the controller 30 may be configured to produce new music when the period of the periodic noise signal changes by the preset ratio or more (YES in 1500) during the process of playing the first music.

Referring to FIG. 7, when the period of the periodic noise signal changes by the preset ratio or more (YES in 1500), the controller 30 may select the second song different in BPM from the first song and/or the second beat sound different in amplitude characteristics from the first beat sound (2100).

In various examples, the controller 30 may be configured to select the first song and the first beat sound, without change, which have been used to produce the previous first music even though the period of the periodic noise signal changes by the preset ratio or more.

In the embodiment, the controller 30 may be configured to modulate the second song based on the changed period (hereinafter, referred to as a ‘second period’) of the periodic noise signal (2200).

More specifically, the controller 30 may adjust the tempo of the second song so that the beat period of the second song is N or 1/N (N is a natural number) times the second period of the periodic noise signal.

In addition, the controller 30 may be configured to determine the playing period of the second beat sound so that the playing period of the second beat sound is N or 1/N (N is a natural number) times the period of the periodic noise signal (2250).

Thereafter, the controller 30 may be configured to produce the music made by synthesizing the second song with the adjusted tempo and the second beat sound that is repeated in accordance with the previously determined playing period, and the controller 30 may store the resynthesized music (hereinafter, referred to as the ‘second music’) (2300).

Thereafter, the controller 30 may be configured to control the speaker 40 to stop the output of the first music 2400 and output the second music (2500).

In this case, the controller 30 may be configured to predict the generation point in time of the periodic noise signal based on the second period of the periodic noise signal and control the speaker 40 to play the second music at the predicted generation point in time.

Meanwhile, the controller 30 may be configured to control the speaker 40 to play the second music having passed through the fade-in filter to prevent heterogeneity that the user may feel as the output of the first music is stopped and the second music is outputted.

FIG. 7 illustrates the assumption that the controller 30 selects the second song, which is different in musical characteristics from the first song, and the second beat sound different from the first beat sound. However, according to various embodiments, the first song may be identical to the second song, and the first beat sound may be identical to the second beat sound.

For example, based on the configuration in which the period of the periodic noise signal changes by a preset ratio or more, the controller 30 may readjust the tempo of the first song, redetermine the playing period of the first beat sound, and produce the resynthesized music made by synthesizing the first song with the readjusted tempo and the first beat sound that is repeated in accordance with the redetermined playing period, and the controller 30 may control the speaker 40 to stop the output of the first music and output the resynthesized music.

As another example, based on the configuration in which the period of the periodic noise signal changes by a preset ratio or more, the controller 30 may select the second song different from the first song among at least one song, adjust the tempo of the second song based on the period of the periodic noise signal, redetermine the playing period of the first beat sound based on the period of the periodic noise signal, and produce the resynthesized music (second music) made by synthesizing the second song with the adjusted tempo and the first beat sound that is repeated in accordance with the redetermined playing period, and the controller 30 may control the speaker 40 to output the resynthesized music (second music).

As another example, based on the configuration in which the amplitude of the periodic noise signal changes by a preset ratio or more, the controller 30 may select the second beat sound different from the first beat sound among at least one beat sound and produce the resynthesized music (second music) made by synthesizing the first song with the adjusted tempo and the second beat sound that is repeated in accordance with the determined playing period, and the controller 30 may control the speaker 40 to output the resynthesized music (second music).

As another example, the controller 30 may select the second song different from the first song among at least one song based on the configuration in which the period of the periodic noise signal changes by a first preset ratio or more. Further, the controller 30 may select the second beat sound different from the first beat sound among at least one beat sound based on the configuration in which the amplitude of the periodic noise signal changes by a second preset ratio or more. Further, the controller 30 may adjust the tempo of the second song based on the period of the periodic noise signal, determine a playing period of the second beat sound based on the period of the periodic noise signal, and produce resynthesized music (second music) made by synthesizing the second song with the adjusted tempo and the second beat sound that is repeated in accordance with the determined playing period, and the controller 30 may control the speaker to output the resynthesized music (second music).

That is, the song and the beat sound, which constitute the second music, may be different from or identical to the song and the beat sound that constitute the first music.

However, the musical characteristics of the second music are different from the musical characteristics of the first music.

According to the present disclosure, the user may not recognize the periodic noise because of the music that masks the periodic noise.

In addition, according to the present disclosure, in case that the characteristics of the periodic noise signal are changed, the user may not recognize the periodic noise by changing the music outputted through the speaker 40 in real time.

In addition, in case that the system 1 for masking periodic noise according to the present disclosure may be provided in a vehicle that frequently generates periodic noise, it may be possible to efficiently prevent the noise from being transmitted to an occupant.

In addition, according to the present disclosure, the user may listen to the user's favorite music without recognizing the periodic noise.

According to various embodiments, even though the period of the periodic noise signal may be changed during the process of playing the first music, the system 1 for masking periodic noise may play the second music after the playing time of the first music elapses.

That is, the controller 30 may control the speaker 40 to play the second music based on the configuration in which the output of the first music may be stopped after the playing time of the first music elapses even though the period of the periodic noise signal may be changed during the process of playing the first music.

According to the present disclosure, it may be possible to improve the user's satisfaction by preventing another song from being played before one song may not be ended.

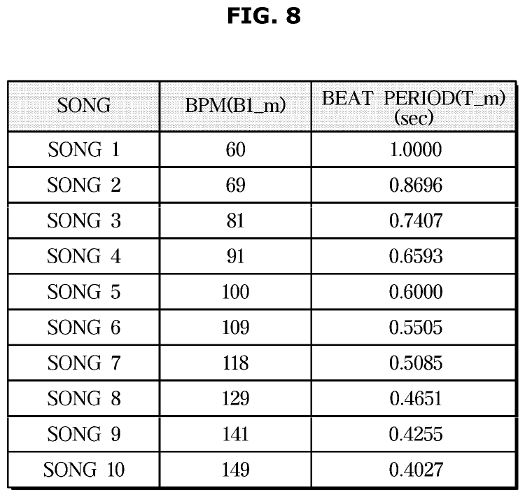

Hereinafter, a specific example of a process of synthesizing the music will be described with reference to FIGS. 8 to 10.

FIG. 8 is a view illustrating examples of information on songs stored in the memory according to the embodiment.

As illustrated in FIG. 8, the plurality of songs stored in the song storage 320 may have different BPM. The song storage 320 may store the sound source data corresponding to the songs and store the BPM information and/or beat period information corresponding to the songs.

For the convenience of description, the assumption is made that the plurality of songs includes Songs 1 to 10. However, the present disclosure is not limited to the types of the plurality of songs and the number of songs.

The plurality of songs may have different BPM. When BPM is 60, the BPM means 60 beats per one minute, and the beat period is 1 second.

That is, the beat period T_M of the song may be determined by the BPM B1_M of the song based on Equation 1 below.

T_M=60/B1_M Equation 1

The beat periods corresponding to various BPM are shown in the drawings.

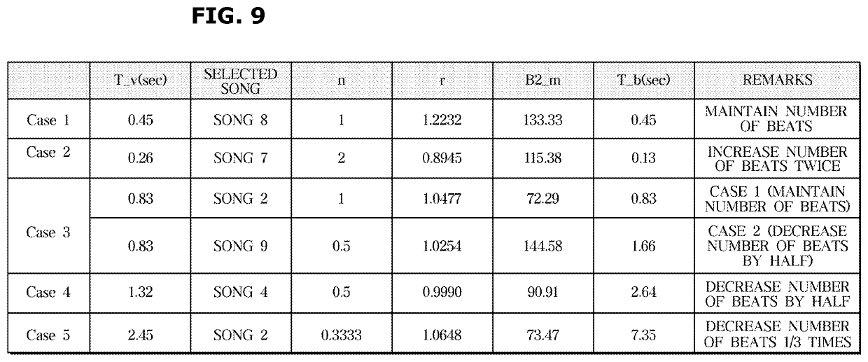

FIG. 9 is a view illustrating examples of elements that constitute music produced based on a period of a periodic noise signal.

Referring to FIG. 9, an example may be ascertained, in which the modulator 350 modulates songs and determines playing periods of beat sounds in respect to a plurality of cases in which periods of periodic noise signals may be different from one another.

In the table, T_V means a period of a periodic noise signal, N means a multiple of a preset beat, R means a BPM change ratio, B2_M means BPM of a song with an adjusted tempo, and T_B means a playing period of a beat sound. The multiple of the beat corresponds to a natural number or an inverse number of a natural number.

Referring to CASE 1, when the period T_V of the periodic noise signal may be 0.45 seconds, the controller 30 may select Song 8 having beat period T_M most similar to the period T_V of the periodic noise signal among Songs 1 to 10 (Song 8 has a beat period of 0.4651).

The controller 30 may determine that the multiple N of the beat may be 1 based on the configuration in which a difference between the period T_V of the periodic noise signal and the beat period T_M of Song 8 may be a critical value or less.

The controller 30 may calculate the BPM change ratio R of the song selected based on the period T_V of the periodic noise signal.

Thereafter, the BPM change ratio R of Song 8 may be calculated based on Equation 2 below.

R=T_M/(T_V*N) Equation 2

The BPM change ratio R of Song 8 may be determined as 1.2232 by means of Equation 2.

Thereafter, the BPM B2_M of Song 8 with the adjusted tempo may be calculated based on the calculated BPM change ratio R by Equation 3 below.

B2_M=T_M*N Equation 3

The BPM of Song 8 with the adjusted tempo may be determined as 133.33 by means of Equation 3.

In addition, the controller 30 may select any one beat sound among the plurality of beat sounds and determine the playing period T_B of the beat sound selected based on Equation 4.

T_B=T_V/N Equation 4

The playing period of the beat sound may be determined as 0.45 seconds by means of Equation 4. That is, in case that the multiple N of the beat is set to 1, the playing period of the beat sound may be equal to the period T_V of the periodic noise signal.

Referring to CASE 2, in case that T_V is 0.26 seconds, the controller 30 may select Song 7 in which 1/N (N=2) times the beat period is most similar to 0.26 seconds.

Thereafter, values of R, B2_M, and T_B may be calculated by means of Equations 1 to 4.

Referring to CASE 3, in case that T_V is 0.83 seconds, the controller 30 may select Song 2 having the beat period most similar to 0.83 seconds or select Song 9 in which N (N=2) times the beat period is most similar to 0.83 seconds.

Referring to CASE 4, in case that T_V is 1.32 seconds, the controller 30 may select Song 4 in which N (N=2) times the beat period is most similar to 1.32 seconds.

Referring to CASE 5, in case that T_V is 2.45 seconds, the controller 30 may select Song 2 in which N (N=3) times the beat period is most similar to 2.45 seconds.

As described above, the above-mentioned ratio calculator 351 may select any one song from the plurality of songs and calculate the BPM change ratio of the selected song.

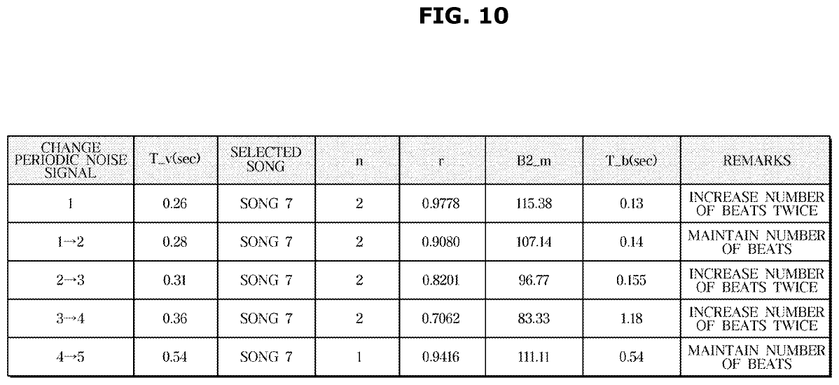

FIG. 10 is a view illustrating an example in which tempos of songs and playing periods of beat sounds may be adjusted in case that the period of the periodic noise signal changes.

Referring to FIG. 10, in case that the period T_V of the periodic noise signal is 0.26 seconds, Song 7 may be selected. The tempo of Song 7 may be adjusted based on the BPM change ratio (R=0.9778) so that the BPM B2_M is 115.38. The playing period T_B of the beat sound may be determined as 0.13 seconds.

Thereafter, in case that the period T_V of the periodic noise signal changes from 0.26 seconds to 0.28 seconds, the selected song may be maintained as Song 7 without change. However, the tempo of Song 7 may be readjusted by the BPM change ratio (R=0.9080), and the playing period T_B of the beat sound may also be redetermined as 0.14 seconds.

Thereafter, in case that the period T_V of the periodic noise signal changes from 0.28 seconds to 0.31 seconds, the selected song may be maintained as Song 7 without change. However, the tempo of Song 7 may be readjusted by the BPM change ratio (R=0.8201), and the playing period T_B of the beat sound may also be redetermined as 0.155 seconds.

Thereafter, in case that the period T_V of the periodic noise signal changes from 0.31 seconds to 0.36 seconds, the selected song may be maintained as Song 7 without change. However, the tempo of Song 7 may be readjusted by the BPM change ratio (R=0.7062), and the playing period T_B of the beat sound may also be redetermined as 0.18 seconds.

Thereafter, in case that the period T_V of the periodic noise signal changes from 0.36 seconds to 0.54 seconds, the selected song may be maintained as Song 7 without change. However, the multiple N of the beat decreases by half, the tempo of Song 7 may be readjusted by the BPM change ratio (R=0.9416), and the playing period T_B of the beat sound may also be redetermined as 0.54 seconds.

According to the present disclosure, it may be possible to efficiently mask the periodic noise only by adjusting the multiple of the beat, the BPM change ratio, and the playing period of the beat sound without changing the songs.

On the other hand, the disclosed embodiments may be implemented in the form of a recording medium that stores computer-executable commands. The command may be stored in the form of a program code. When the command may be executed by a processor, a program module may be generated, and operations of the disclosed embodiments may be performed. The recording medium may be implemented as a computer-readable recording medium.

Examples of the computer-readable recording medium include all kinds of recording media for storing commands readable by a computer. Examples of the computer-readable recording medium may include a read only memory (ROM), a random-access memory (RAM), a magnetic tape, a magnetic disc, a flash memory, an optical data storage device, and the like.

According to the present disclosure, it may be possible to efficiently mask various types of periodic noise.

In addition, according to the present disclosure, it may be possible to mask the periodic noise by using the music outputted with comparatively low sound volume.

In addition, according to the present disclosure, the user may listen to the user's favorite music without recognizing the periodic noise.

In addition, according to the present disclosure, the period of the periodic noise may be coincident with the tempo of the music and the period of the beat sound, such that the periodic noise may be naturally masked. Therefore, the user may listen to the user's favorite music without recognizing the periodic noise.

In addition, according to the present disclosure, the user may live everyday life without being affected by the noise in situations such as when floor noise may be generated in the common residential building or when periodic impactive noise occurs at the construction site.

As described above, the embodiments have been described with reference to the accompanying drawings. A person skilled in the art may understand that the present disclosure may be carried out in other forms different from those disclosed in the embodiments without changing the technical spirit or the essential features of the present disclosure. The disclosed embodiments may be illustrative and should not be interpreted as being restrictive.

What is claimed is:

1. A system for masking periodic noise, the system comprising:
at least one sensor configured to detect a periodic noise signal;
at least one memory having stored at least one song and at least one beat sound;
a speaker; and
at least one processor configured to:
select a first song and a first beat sound from the at least one song and the at least one beat sound based on at least one of a period and an amplitude of the periodic noise signal,
adjust a tempo of the first song based on the period of the periodic noise signal to an adjusted tempo,
determine a playing period of the first beat sound based on the period of the periodic noise signal, and
control the speaker to output music made by synthesizing the first song with the adjusted tempo and the first beat sound that is repeated in accordance with the playing period.

2. The system of claim 1, wherein the at least one processor is further configured to adjust the tempo of the first song to the adjusted tempo so that a beat period of the first song is N or 1/N times the period of the periodic noise signal, and N is a natural number.

3. The system of claim 1, wherein the at least one processor is further configured to determine the playing period of the first beat sound so that the playing period of the first beat sound is N or 1/N times the period of the periodic noise signal, and N is a natural number.

4. The system of claim 1, wherein the at least one processor is further configured to adjust a playing point in time of the music so that a beat of the periodic noise signal is coincident with a beat of the music.

5. The system of claim 4, wherein the at least one processor is further configured to predict a generation point in time of the periodic noise signal based on the period of the periodic noise signal and control the speaker to play the music at the predicted generation point in time.

6. The system of claim 1, wherein based on the period of the periodic noise signal being changed by a preset ratio or more, the at least one processor is further configured to readjust the tempo of the first song, redetermine the playing period of the first beat sound, produce resynthesized music made by synthesizing the first song with the readjusted tempo and the first beat sound repeated in accordance with the redetermined playing period, stop an output of the music, and control the speaker to output the resynthesized music.

7. The system of claim 1, wherein the at least one song comprises at least two songs and wherein based on a the period of the periodic noise signal being changed by a preset ratio or more, the at least one processor is further configured to select a second song different from the first song from the at least one song, adjust a second tempo of the second song based on the period of the periodic noise signal to a second adjusted tempo, redetermine the playing period of the first beat sound based on the period of the periodic noise signal, and control the speaker to output resynthesized music made by synthesizing the second song with the second adjusted tempo and the first beat sound that is repeated in accordance with the redetermined playing period.

8. The system of claim 1, wherein at least one beat sound comprises at least two beat sounds and wherein based on the amplitude of the periodic noise signal being changed by a preset ratio or more, the at least one processor is further configured to select a second beat sound different from the first beat sound from the at least one beat sound and control the speaker to output resynthesized music made by synthesizing the first song with the adjusted tempo and the second beat sound that is repeated in accordance with the determined playing period.

9. The system of claim 1, wherein the at least one song comprises at least two songs and the at least one beat sound comprises at least two beat sounds and wherein based on the period of the periodic noise signal being changed by a first preset ratio or more, the at least one processor is further configured to select a second song different from the first song from the at least one song, select a second beat sound different from the first beat sound from the at least one beat sound based on the amplitude of the periodic noise signal being changed by a second preset ratio or more, adjust a tempo of the second song based on the period of the periodic noise signal, determine a playing period of the second beat sound based on the period of the periodic noise signal, and control the speaker to output resynthesized music made by synthesizing the second song with the adjusted tempo and the second beat sound that is repeated in accordance with the determined playing period.

10. The system of claim 1 wherein the at least one processor is further configured to control the speaker to play the resynthesized music having passed through a fade-in filter.

11. A method of masking periodic noise, the method comprising:
detecting a periodic noise signal;
selecting a first song and a first beat sound from pre-stored at least one song and pre-stored at least one beat sound based on at least one of a period and an amplitude of the periodic noise signal;
adjusting a tempo of the first song based on the period of the periodic noise signal;
determining a playing period of the first beat sound based on the period of the periodic noise signal; and
playing music made by synthesizing the first song with the adjusted tempo and the first beat sound that is repeated in accordance with the determined playing period.

12. The method of claim 11, wherein the adjusting of the tempo of the first song comprises adjusting the tempo of the first song so that a beat period of the first song is N or 1/N times the period of the periodic noise signal, where N is a natural number.

13. The method of claim 11, wherein the determining of the playing period of the first beat sound comprises determining the playing period of the first beat sound so that the playing period of the first beat sound is N or 1/N times the period of the periodic noise signal, where N is a natural number.

14. The method of claim 11, wherein the playing of the music comprises adjusting a playing point in time of the music so that a beat of the periodic noise signal is coincident with a beat of the music.

15. The method of claim 14, wherein the adjusting of the playing point in time of the music comprises:
predicting a generation point in time of the periodic noise signal based on the period of the periodic noise signal; and
playing the music at the predicted generation point in time.

16. The method of claim 11, further comprising:
readjusting the tempo of the first song and redetermining the playing period of the first beat sound based on the period of the periodic noise signal being changed by a preset ratio or more;
producing resynthesized music made by synthesizing the first song with the readjusted tempo and the first beat sound repeated in accordance with the redetermined playing period; and
stopping the playing of the music and playing the resynthesized music.

17. The method of claim 11, where at least one song comprises at least two songs, and the method further comprising:
selecting a second song different from the first song from the at least one song based on the period of the periodic noise signal being changed by a preset ratio or more;
adjusting a tempo of the second song based on the period of the periodic noise signal;
redetermining the playing period of the first beat sound based on the period of the periodic noise signal; and
playing resynthesized music made by synthesizing the second song with the adjusted tempo and the first beat sound that is repeated in accordance with the redetermined playing period.

18. The method of claim 11, wherein at least one beat sound comprises at least two beat sounds, and the method further comprising:
selecting a second beat sound different from the first beat sound from the at least one beat sound based on the amplitude of the periodic noise signal being changed by a preset ratio or more; and
playing resynthesized music made by synthesizing the first song with the adjusted tempo and the second beat sound that is repeated in accordance with the determined playing period.

19. The method of claim 11, further comprising:
selecting a second song different from the first song from the at least one song based on the period of the periodic noise signal being changed by a first preset ratio or more;
selecting a second beat sound different from the first beat sound from the at least one beat sound based on the amplitude of the periodic noise signal being changed by a second preset ratio or more;
adjusting a tempo of the second song based on the period of the periodic noise signal;
determining a playing period of the second beat sound based on the period of the periodic noise signal; and
playing resynthesized music made by synthesizing the second song with the adjusted tempo and the second beat sound that is repeated in accordance with the determined playing period.

20. The method of claim 16, wherein the playing of the resynthesized music comprises playing the resynthesized music having passed through a fade-in filter.
